(19) United States
(12) Patent Application Publication
(10) Pub. No.: US 2002/0006821 A1
(43) Pub. Date: Jan. 17, 2002

(54) Lottery service system and method based on the internet

(76) Inventor: Jae G. Park, Anyang-city (KR)

Correspondence Address: HARNESS, DICKEY & PIERCE, PLC, P.O. BOX 828, BLOOMFIELD HILLS, MI, 48303, US

(21) Appl. No.: 09/897,539

(22) Filed: Jul. 2, 2001

(30) Foreign Application Priority Data
Jul. 4, 2000 (KR) 2000-37931

(51) Int. Cl. G06F 19/00

(52) U.S. Cl. 463/17

(57) ABSTRACT

A lottery service system and method based on the internet is provided, capable of issuing lottery tickets on a corresponding date every day and confirming whether winning lottery numbers exist by conducting a draw at a predetermined reference time of the day on which the lottery tickets are issued, based on the internet. In particular, it is characterized in that users randomly input numbers they want and winning numbers are selected by letters and numbers having the highest or lowest incidence in corresponding places.

### BACKGROUND OF THE INVENTION

1. Field of the Invention

The present invention relates to lottery service system and method based on the internet, and more particularly to lottery service system and method based on the internet, capable of randomly inputting for storage numbers internet-connected users themselves wish on corresponding dates everyday based on the internet, selecting as a winning number letters or numbers having the highest incidence at corresponding places of the winning number in the stored lottery numbers galore, and carrying out a draw at a predetermined reference time of the day to confirm whether the winning number exists.

2. Description of the Prior Art

In general, most cases in purchasing lottery tickets are to use kiosks or shops that sell lottery tickets users wish. That is, lottery tickets are purchased in offline through lottery ticket-selling kiosks, banks, lottery tickets-dealing stalls, or the like, and, in case of draw-type lottery tickets rather than instant lottery tickets (or scratch-type lottery tickets), a certain period of time is required till a draw is completed and a ticket buyer confirms a winning number after the purchase of the ticket. Therefore, there exists a problem in that ticket bearers can lose their tickets during the period of time till the draw. Further, a problem rises in that the draw transparency can not be secured except for the tickets for which a draw is carried out in an open way through part of mass media.

Further, another problem existing in the conventional way, if prizes come to an amount of money more than a certain amount in both instant and draw-type lottery tickets, is the inconvenience for winners to drop in at an institution that pays the lottery winning amount of money(or the prize money) to get the prizes.

Further, even though services issuing lottery tickets online in the use of central computers and terminals are carried out in order to solve a problem of incurring expenditures for issuing printed lottery tickets to be documented as stated above and a problem of wasting non-issued lottery tickets, since an online lottery ticket issuing service system does not store information on users, there exists a problem in that lottery ticket applicants keep numbers they inputted on separate printed paper or lottery ticket numbers randomly chosen from the central computer in order to identify their winnings through draws.

As stated above, the existing lottery ticket system has problems of incurring expenditures, inconvenience in time and space for purchases, excessive expenditures for building online lottery tickets, and so on, due to the structure itself.

### SUMMARY OF THE INVENTION

In order to solve the above problems, an internet lottery service system according to the present invention comprises at least one or more user computers 3 having communication units and for carrying out connections through an internet communication network and participating in lottery services, a database 2 for storing user information inputted for member registrations by internet-connected users and lottery numbers inputted for participations in lottery draws by the users, a web server 1 enabling the users to input prospective winning numbers of predetermined digits through the user computers 3, a web server 1 for providing internet lottery services by extracting letters or numbers inputted in the highest incidence from respective places of the users' prospective winning numbers as a winning number, and a financial institution server 5 in financial institutions or electronic settlement companies for settling the costs of lottery tickets for the users and paying prize money.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing a structure of an entire system according to an embodiment of the present invention;

FIG. 2 is a view for showing a structure of a web server according to an embodiment of the present invention;

FIG. 3a is a view for schematically showing a sitemap of a web site according to the present invention;

FIG. 3b is a view for showing a web page outputting lottery draw results for an example;

FIG. 3c is a view for showing a web page constructed to carry out lottery ticket purchases through games for an example;

FIG. 4 is a view for schematically showing structures of tables of a database according to an embodiment of the present invention;

FIG. 5 is a view for showing an entire process for a lottery draw according to an embodiment of the present invention;

FIG. 6 is a view for showing subroutines for a processing order of a lottery draw out of the entire process; and

FIG. 7 is a view for showing subroutines for a payment order of prize money.

### DETAILED DESCRIPTION OF THE PREFERRED EMBODIMENT

In lottery service system and method based on the internet according to an embodiment of the present invention to achieve the above object, users connect to a web server for providing internet lottery services according to the present invention through the internet via user computers, carries out member registrations, and obtains IDs and passwords. The users registered as members execute logins by using the IDs and passwords, input prospective winning numbers, and pay a lottery ticket costs by a predetermined electronic payment unit. The inputted prospective winning numbers are stored in a database, a winning number of a group and the number of corresponding places in number is extracted based on numbers inputted by users at a certain time every day and then the winning number is determined, and, in case there is the winning number among the users, prize money is paid on an online deposit way to a lottery winner by an institution that executes as agency the payment of the prize money after deducting a certain amount of costs from the prize money.

If there is not a winner upon drawing, the prize money is transferred to the next day so as to be added to prize money of the next day, so that the added prize money is paid through predetermined procedures to a newly winning user.

The prospective winning numbers inputted by the users may be stored together with users information in a form of an automatic backup compact disc of a prior art, preventing the prospective winning numbers from being manipulated by accessing a database itself.

The users participate in lottery draws with their own IDs and passwords, and the number of participation times a day is limited. The lottery draw takes place at a predetermined reference time every day, and the users can connect to the site to check whether they are winners, or be notified by using e-mails and the like. Prize money is automatically deposited to a winner's account by a financial institution having a contract of predetermined standards with the web site.

The prospective lottery numbers inputted by the users may be stored in a predetermined encrypted fashion together with users information, preventing the lottery numbers from being manipulated by accessing a database server.

Hereinafter, the present invention will be described in detail with reference to the attached drawings showing an embodiment of the present invention.

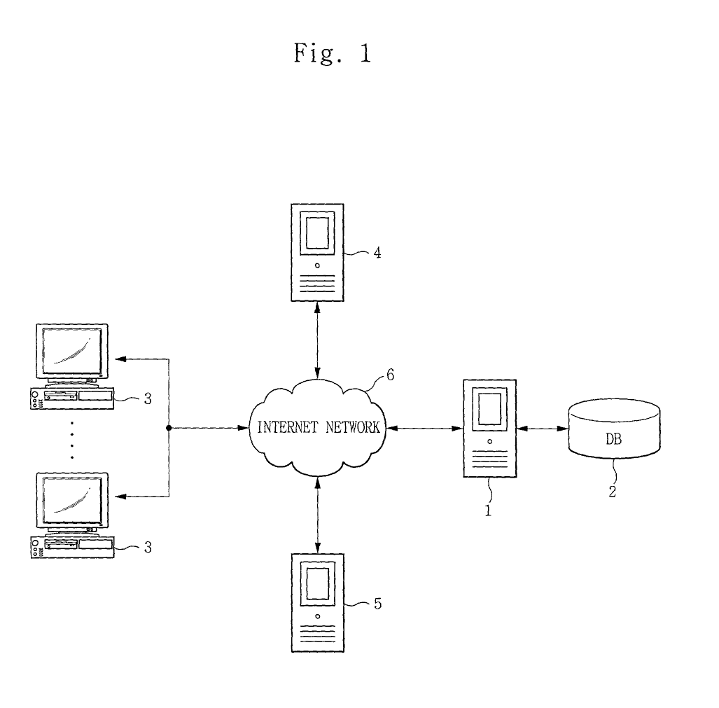

FIG. 1 is a view for showing a structure of an entire system of an internet lottery service system according to an embodiment of the present invention.

The internet lottery service system according to an embodiment of the present invention comprises at least one or more user computers 3 having communication units and for carrying out connections through an internet communication network and participating in lottery services, a database 2 for storing user information inputted for member registrations by internet-connected users and lottery numbers inputted for participations in lottery draws by the users, a web server 1 enabling the users to input prospective winning numbers of predetermined digits through the user computers 3, a web server 1 for providing internet lottery services by extracting letters or numbers inputted in the highest incidence from respective places of the users' prospective winning numbers as a winning number, and a financial institution server 5 in financial institutions or electronic settlement companies for settling the costs of lottery tickets for the users and paying prize money.

The above web server 1 includes a storage unit 22 for playing a role of an interface for users to receive internet lottery services and storing web contents, a database engine 23 for controlling the database, an electronic payment unit 26 for processing lottery service costs of the users, a lottery draw unit 24 for drawing a winning number based on lottery numbers the users input, and a control unit 21 for controlling a system and a communication unit 25 of performing communications with external.

The web server 1 performs online lottery ticket sales, prize money calculation, and so on, and preferably has an essential encryption unit. The encryption unit prevents information inputted by individuals from being exposed and inputted lottery numbers from being manipulated to be changed, and is for identifying users on the internet.

Further, the database 2 as a constituent of the present invention includes a distinction method such as a system date and the like based on a certain period during the inputs of lottery numbers, and stores the ticket numbers in the read-only storage unit, so as to preferably prevent the lottery ticket numbers from being changed or manipulated, which can be realized by using a method such as a real-time compact disc storage method and the like. Further, users can keep their ticket numbers in their own computers to identify their ticket numbers, and, if a corresponding user carries out logins upon drawing, a ticket number the corresponding user has inputted is displayed on a lottery service page of a web browser from the database 2, so there is no need to print lottery tickets.

Structures and operations of the web page storage unit and lottery draw unit out of the constituents will be described in more detail with reference to the following drawing.

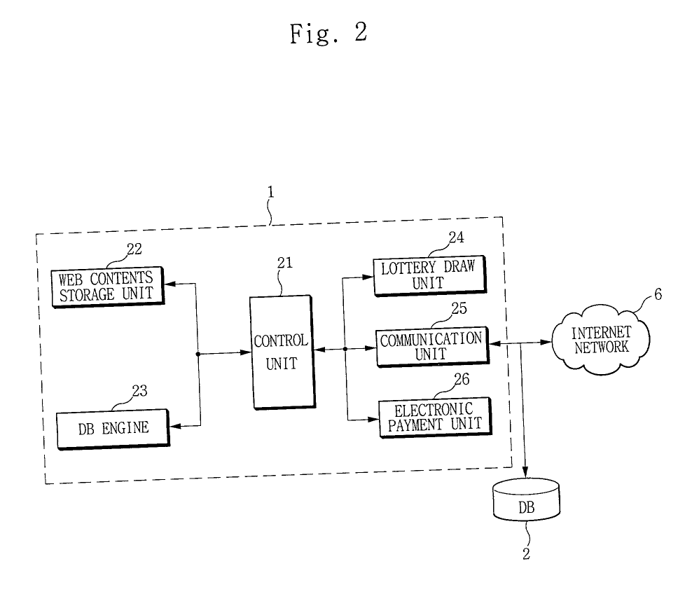

FIG. 2 is a view for a showing a structure of the web server 1 according to an embodiment of the present invention. The web server 1 according to an embodiment of the present invention includes the control unit 21 in charge of system operations as a conventional central processing unit and for driving a control program of respective constituents, the web contents storage unit 22 for storing a predetermined program of carrying out member registrations, executing users' logins, and enabling the users to participate in lottery draws, and web contents such as document forms and the like, the database engine 23 for updating, deleting, adding, and searching users information, lottery numbers, contents to be stored in web contents, bulletin board contents, or the like, the lottery draw unit 24 for extracting a winning number by interconnecting lottery numbers the users have inputted with the database engine 23, and the electronic payment unit 26 as a payment unit for receiving predetermined costs for users' participations in lottery draws and paying prize money to the users in case of there is a winning number.

The electronic payment unit 26 as a payment unit may employ one of diverse payment units such as electronic wallets, cards joined with companies that support electronic payments, electronic cash, automatic transfers, GIRO deposits, payments through cellar phones, and so on, shown in prior arts.

The lottery draw unit 24 as a constituent of the web server is to conduct draws based on lottery numbers that users connected to the site have inputted, rather than the users' selecting and keeping unique numbers as in the conventional lottery draw method, and, in a draw method, the most inputted numbers are extracted from the lottery numbers that the users who participate in lottery draws have inputted instead of a method generally used for randomly extracting digits of a number, and a winner is decided by extracting the same lottery number as the winning number extracted out of the lottery numbers the users have inputted through the interconnection with the database engine 23, the lottery draw unit includes a program for finding out a letter of a group or numbers having the highest incidence from every group extracted by the database engine and carries out functions of extracting the same number of digits from the numbers inputted by digit place, finding out the highest value or the lowest value as to a magnitude value of the number from the same number of digits extracted, and inputting the numbers for corresponding places of a lottery winning number.

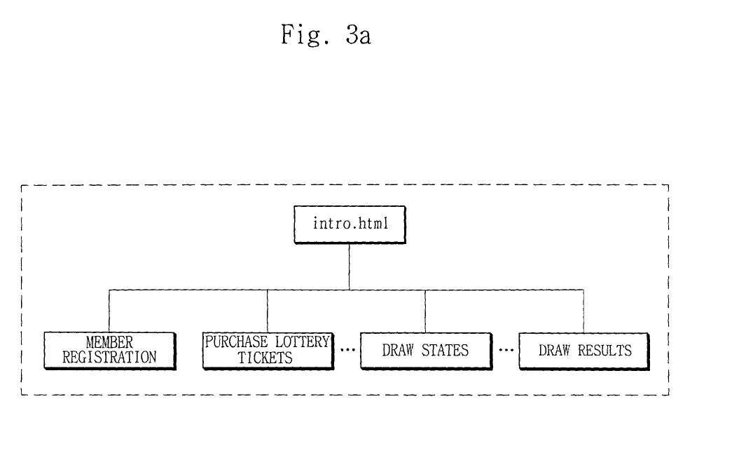

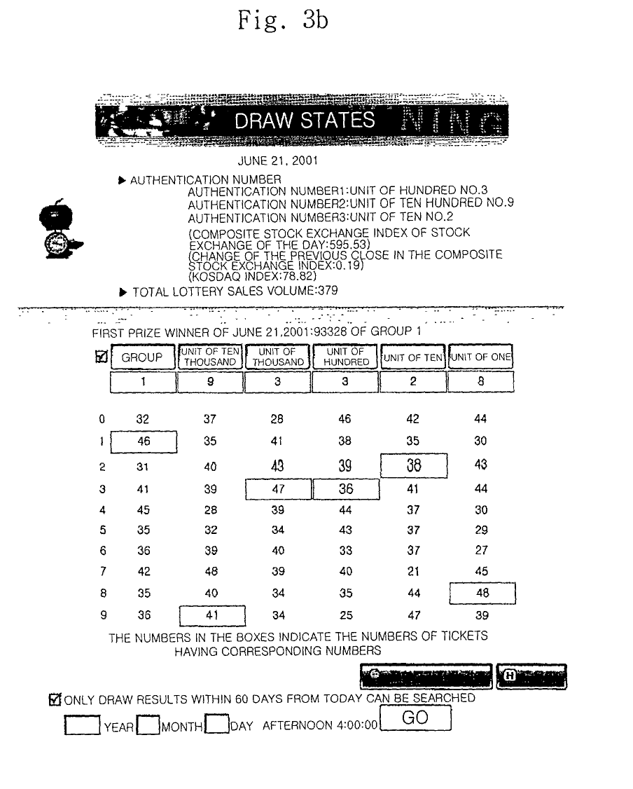

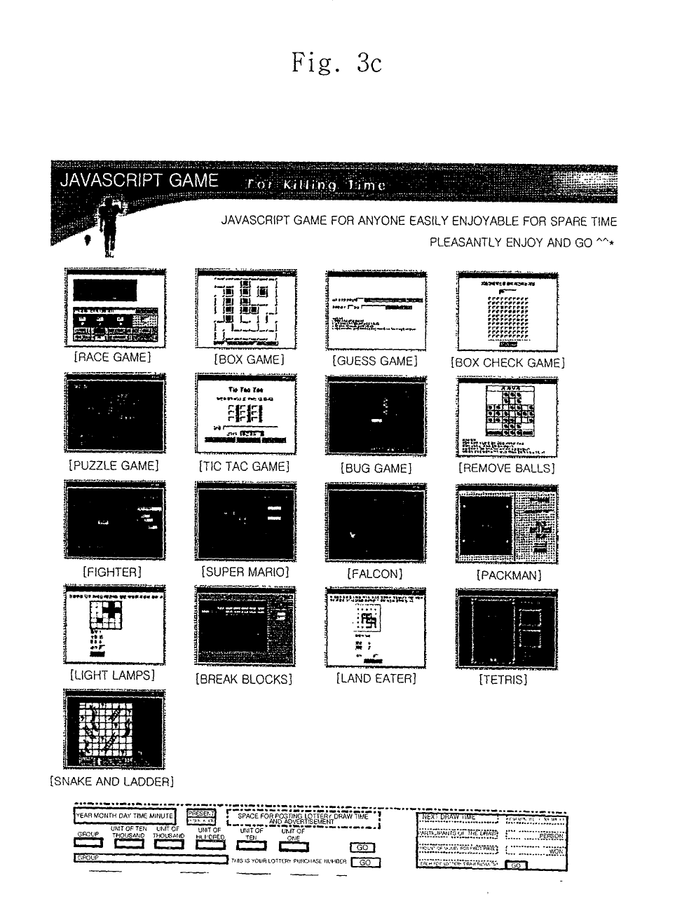

FIG. 3a is a view for schematically showing a sitemap of a web site according to an embodiment of the present invention.

If users connect to the site, an initial screen as a main screen is displayed on a wire/wireless internet web browser driven in user computers, and icons allowing movements to submenu screens such as member registrations, ticket purchases, draw situations, draw results, games(not shown) and so on, and information such as introduction to site, and so on are outputted.

Web contents according to a lottery service system based on the internet has a lottery page which has a lottery number input, a search window enabling drawn lottery numbers to be inquired, a transferred balance display portion for displaying transferred balances remaining after deductions of administration fees and payments of prize money from the costs paid for users to participate in lottery draws, and a lottery number reservation portion of allowing the users to input dates they wish and lottery numbers of the corresponding dates in case that the users wish to reserve the lottery numbers in advance.

FIG. 3b is an illustrative view for showing a web page outputting lottery draw results.

A lottery draw is carries out by selecting a most inputted number by place, and a composite stock exchange index, a change from previous close in the composite stock exchange index, and a Kosdaq index, in the Stock Exchange of the day is used as an authentication number as stated above. In the generation of the authentication, in case that a composite stock exchange index of the Stock Exchange of the day is xxxx.yz, y designates an authentication unit of an electronic lottery number and z designates an authentication number of the lottery. At this time, since, in the y, digits of a lottery number are 6 digits including a group(number unit of hundred thousand) and Arabic numbers have 10 different numbers, in deciding a number of each place and an authentication number, a 1 or 2 for y indicates the unit of ten thousand, a 3 and 4 for y the unit of thousand, a 5 or 6 for y the unit of hundred, a 7 or 8 for y the unit of ten, and a 9 or 0 for y the unit of one. Further, in case that the other same authentication numbers for authentication exist, a priority order is applied, for example, from Kosdaq index, a change from previous close in the composite stock exchange index, composite stock exchange index of the day, and so on. The above priority order may be diversely changed without restriction of the above order. Accordingly, as shown in FIG. 3b, in case that a composite stock exchange index of the Stock Exchange of the day is 595.53, a change from previous close in the composite stock exchange index of the day is 0.19, a Kosdaq index is 78.82, and a winning lottery number is selected by integrating numbers inputted as shown in FIG. 3b, a winning lottery number of 93328 of group 1 can be obtained.

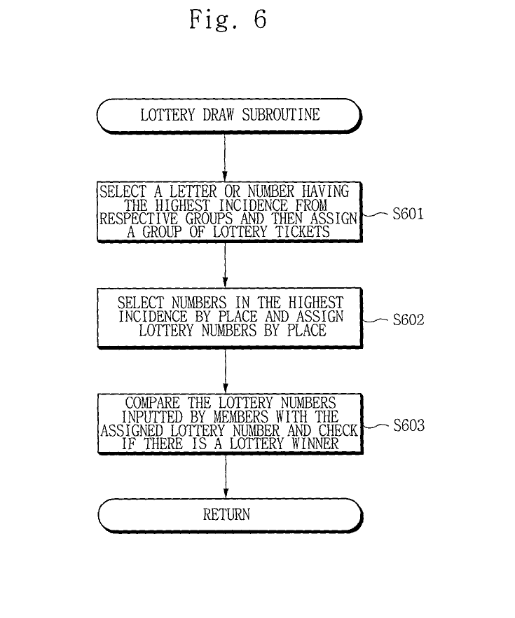

The method for drawing a winning lottery ticket will be described in detail again in FIG. 6.

FIG. 3c is an illustrative view for showing a web page constructed to carry out lottery purchases through games.

As shown in FIG. 3c, a game web page as one constituent of the present invention contains plural games, cyber money or a passbook balance is accumulated based on playing respective games. A purchase order window is provided below to purchase lottery tickets by using the accumulated money in case that the accumulated cyber money or passbook balance is over a predetermined amount of money, and the purchase order window is interconnected with a lottery ticket purchase page in order for users of playing games to purchase lottery tickets during playing games.

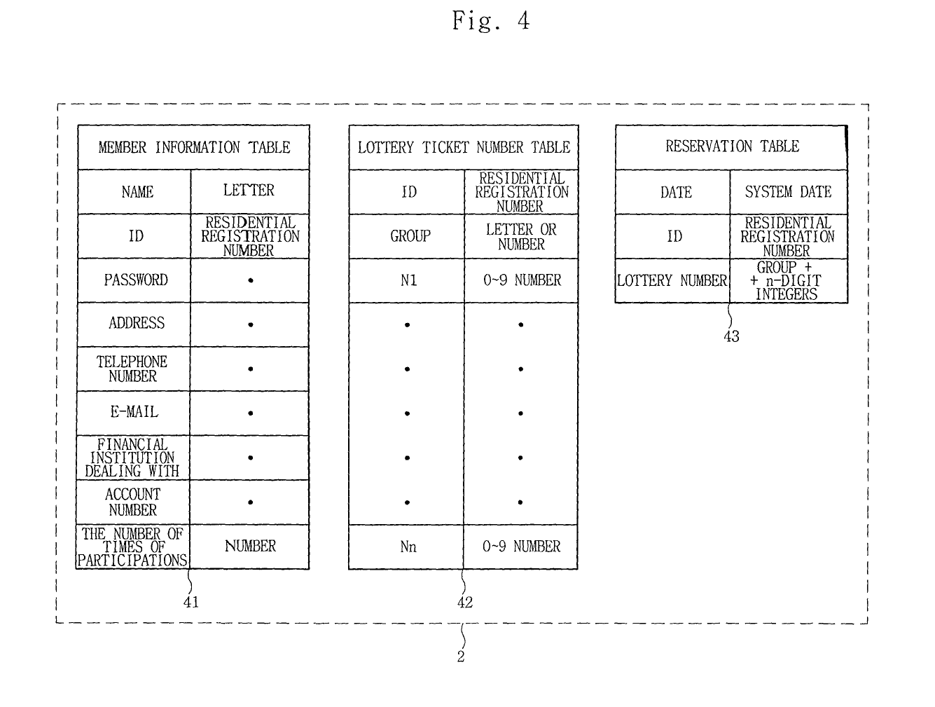

FIG. 4 is a view for schematically showing structures of tables of a database according to an embodiment of the present invention, and, in FIG. 4, only a member information table 41, a lottery number table 42, and a reservation table 43 are shown out of plural data tables stored in a database.

The member information table 41 stores users information necessary for conducing lottery draws and identifying users, such as users' financial institution account numbers for depositing prize money into users' financial institution accounts, names, IDs, passwords, addresses, telephone numbers, e-mail addresses, financial institution names with which users deal, account numbers of the financial institutions with which users deal, the number of times of participations in lottery draws, and so on, for the users registered as members in order to participate in the lottery draws.

The lottery ticket number table 42 as another constituent of FIG. 4 stores corresponding users' IDs and lottery ticket numbers the users input, if the users connect to the web server, select lottery draws, and input lottery numbers they want. The ID items constructed in the member information table and the lottery ticket number table have a duplicate-not-allowed property since the users must be uniquely identified.

The lottery ticket number table 42, as shown in FIG. 3, is searched by the database engine to be used as material for extracting repeated numbers of a letter or number indicating the same group and repeated numbers of the same number in each place of lottery numbers, and the lottery draw unit finds out the maximum value or the least value through a sorting job by places of the extracted repeated numbers, select a letter of a group or a number included in the values and a number inputted at the highest or at the lowest by place, and then produce a winning number. Next, as stated above, a winner is decided by searching a user number corresponding to a winning number extracted by the database engine.

The reservation table 43 stores reservation information such as a reservation lottery number, a desired lottery drawing date, and so on, in order for the users who participates in a lottery draw to participate in future lottery draws instead of participating in a lottery draw of the day, and provides lottery services by using the reservation information in the lottery draw of the corresponding date.

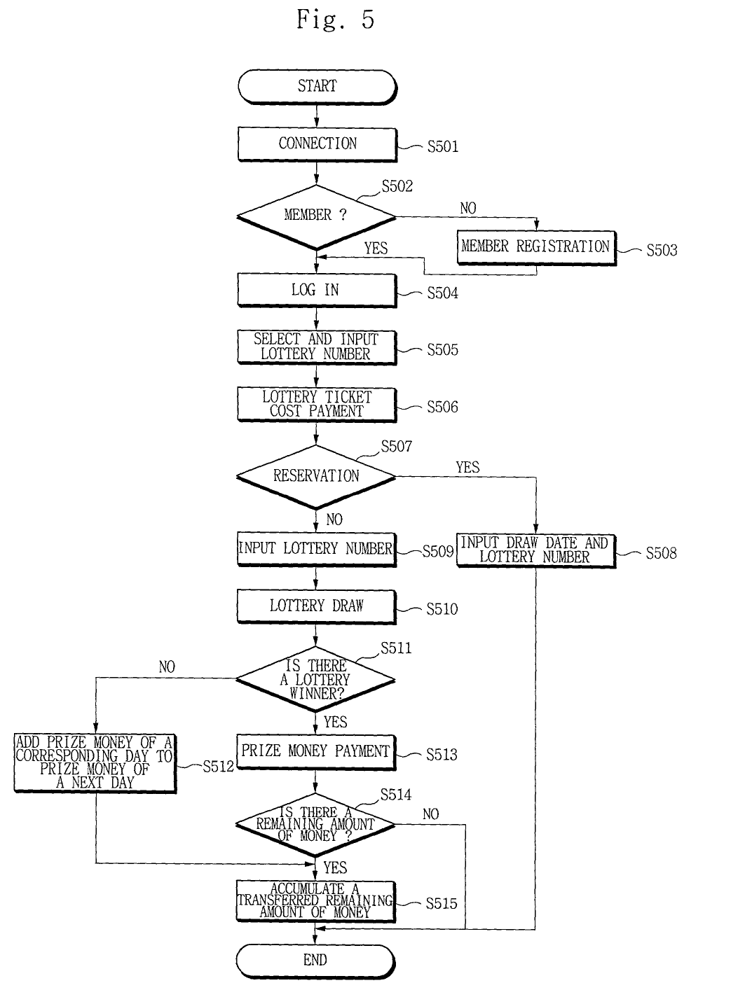

FIG. 5 is a view for showing an entire process for a lottery draw according to an embodiment of the present invention.

In the entire process of the lottery service system based on the internet according to an embodiment of the present invention, users use user computers to connect to the internet network, in case of members, carry out logins, and, in case of non-members, carries out member registrations(S501, S502, S503, and S504).

Through interface screens displayed on the user computers logged in through connections, users select a page for inputting a lottery number they want, and carry out electronic payments as to ticket costs by the predetermined electronic payment unit 26(S505, S506). In the process, the electronic payment unit employed for the electronic payments, as stated above, may use a method for carrying out settlements through card payments, electronic payments using electronic wallets by joining with companies that act the electronic payments for, or chargeable cards as electronic cash by inputting card numbers and secret numbers.

In the process, the users pay the costs incurred by the participations in lottery and the determine if the participations in lottery draws are for the day or reserved(S507). In case that selecting reservations in step S507, the user input the user computers the prospective draw dates and ticket numbers(S508).

In case of not a reservation in step S506, the users input lottery numbers of the predetermined number of digits through the user computers (S509). In the participations of the lottery draw of the day, the number of times that the users can input lottery numbers is limited to the predetermined number of times a day. The limitation to the number of times that the users input lottery numbers is for preventing users' data manipulations as well as adverse effects as gambling properties.

The lottery numbers the users input are transferred to the web server 1 from the user computers, the web server stores the transferred lottery numbers of the users in the database, a winning number is extracted through predetermined procedures from corresponding numbers, and a winner is drawn(S510). Next, it is judged whether a winner exists, and, in case that there is a winner, it is re-judged whether plural winners exist, and then a winner is selected(S511), and prize money is paid to the winner based on a predetermined standard(S513). In step S511, in case that there is no winner, the prize money is transferred to be added to a next day's prize money(S512). In step S513, it is judged whether a balance remaining exists after paying prize money(S514), and, if there is a balance, the balance continues to be transferred and accumulated(S515), so that the entire process of the lottery draw of the day is ended.

FIG. 6 is a view for showing subroutines for a processing order of a lottery draw out of the entire process of FIG. 5.

As shown in FIG. 6, the process of FIG. 6 shows the characteristics of the present invention. If lottery draw participants input random lottery numbers of predetermined digits into the lottery number input portion of a web browser of the user computers 3, the inputted lottery numbers are transferred to the web server together with users information. The web server receiving data signals having the lottery numbers and users information stores the lottery numbers and users information in the lottery ticket number table of the database. Here, the lottery numbers consist of plural numbers or letters.

Next, the process a lottery draw is conducted based on the lottery numbers stored in the lottery ticket number table of the database 2 is carried out by searching whether lottery numbers to be drawn on a corresponding date exist in the reservation table, extracting from the lottery ticket number table 42 the lottery numbers reserved on the corresponding date and the lottery numbers inputted on the day to extract the number of lottery tickets having the same letter or number from each group, obtaining the maximum value or the minimum value through a sorting process by a certain program stored in the lottery draw unit 24, and assigning as a group of a winning lottery ticket the letter or number corresponding to the maximum value or the minimum value(S601).

In step S601, if the group of the winning lottery ticket is decided, next, a winning number is selected place by place. As for a winning number for each place, a number inputted in the highest or lowest incidence for each place of a winning lottery number is determined as the number for the corresponding place of the winning lottery number(S602).

The above lottery draw unit obtains a maximum value or a minimum value as to the number of the same letters or numbers inputted for each place through a descent order extraction by using part of the function of the database engine 23 itself, or automatically executes processing procedures without interruption of an administrator in a computer by a separate program interconnected with the database.

In selecting a winning lottery number, if the maximum number or the minimum number as to the same number for each place is duplicated for the other plural places, in order for a winning lottery ticket to be unique, the duplication problem is solved in a method of selecting the largest number or the smallest number from the numbers determined as the maximum or the minimum number of numbers in the descent or ascent order.

Further, since, based on lottery numbers that users randomly input, a letter or number of a group which has the highest incidence in every digit of the lottery numbers is determined as a winning number of a corresponding place of a winning lottery number, numbers that users prefer in general, for example, 3, 5, 7, and so on, are frequently inputted, so that diversity may be lost in winning lottery numbers.

In order to prevent such specific numbers from being concentrated and secure the diversity of winning lottery numbers, numbers in arbitrary places of a winning lottery number may be determined through notarization conducted by notarial institutions such as attorneys, solicitors, financial institutions, and so on, or inserted in arbitrary places of a winning lottery number by naming a separate notary public. By doing so, the diversity of winning lottery numbers can be secured.

Another method for assigning winning numbers in arbitrary places is to use a Kosdaq index of the day, a composite stock exchange index, and a change from previous close in the composite stock exchange index. In using the composite stock exchange index, a composite stock exchange index corresponding upon a draw of the day may be used, and, further, a closing composite stock exchange index of the day which is calculated on closing a stock market of the day may be used.

In general, a composite stock exchange index is expressed in a form of xxxx,ab. Here, a number indicating the number of places may be the number a of the first place below the decimal point, and the number b of the second place below the decimal point may be a winning lottery number in the number of places determined by the number a. Further, in case that a winning lottery number has five digits, and, the number a being a 1 or a 6 becomes the unit of group, a 2 or a 7 the unit of thousand, a 3 or a 8 the unit of hundred, a 4 or a 9 the unit of ten, and a 5 or a 0 the unit of one, so that the randomness of a winning lottery number may increase. It is to use only the places below the decimal point from the composite stock exchange index because the numbers over the decimal point are predictable but the numbers below the decimal point may not be easily predicted.

Methods based on the Kosdaq index and the change from previous close in the composite stock exchange index are the same as that of using the stock exchange index of the day as mentioned above.

The place of the number for respective numbers may be changed, and it is obvious that the winning lottery number is not defined to 5 digits.

In setting the numbers of respective places of the above winning lottery number, in case that there exist a duplicated number in the maximum or minimum number of numbers, a number just before or after the number having the maximum or minimum number of numbers is selected based on the descent order or the ascent order.

Even in this step, a process proceeds with the database engine(DB engine) 23 and the lottery draw unit 26 interconnected.

If a winning lottery number is decided in the step S602 stated above, the database engine 23 searches and extracts a user-inputted lottery number matching with the winning lottery number from the lottery ticket number table 42 and the reservation table of the database 2, to thereby select a lottery winner(S603). In this step, the lottery winner may be only one or plural persons because it is allowed that identical lottery numbers can be inputted.

In the step of selecting winners, the same lottery numbers as a winning lottery number can be chosen as well as diverse grades can be given in the same manner as in conventional lottery draws, for example, in case of the same number with a different group, in case of a lottery number having a different last number from a winning lottery number, and in case of the same number in the place of one and of the same numbers in the places of one and ten as in general lottery tickets, and so on. Such a processing step is executed with the above database engine 23 and the lottery draw unit interconnected.

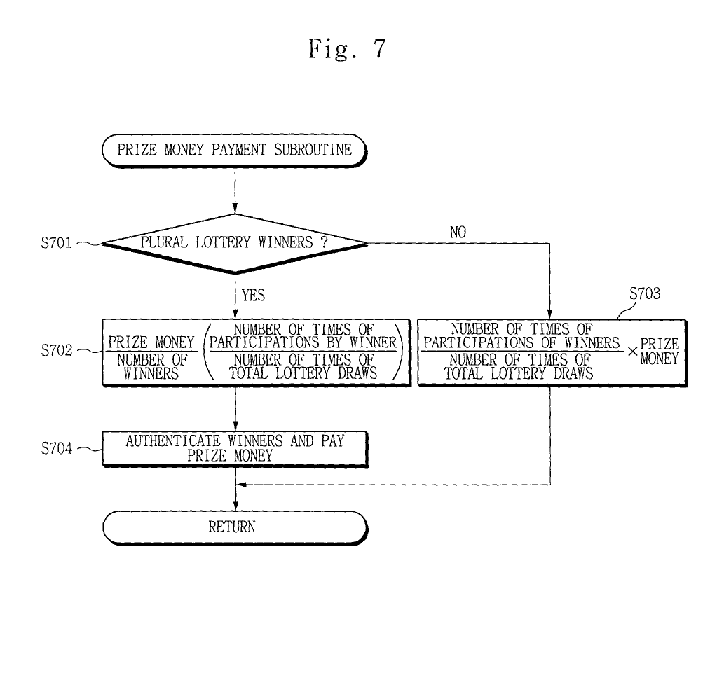

FIG. 7 is a view for showing subroutines indicating a payment order of prize money out of the entire process of FIG. 5.

As shown in FIG. 7, if a winner is decided in step 6 of FIG. 6, prize money is paid to the winner. In the step, it is necessary that winning lottery numbers are classified and prize money is calculated based on a predetermined standard, which are processed in the lottery draw unit 26.

The following is a processing order in the method of paying prize money.

If a winning lottery number is decided and a name list and rankings of winners are determined in the lottery draw unit, it is judged whether winners by ranking are plural or not(S701).

In case of plural winners, in paying prize money allocated by ranking, the prize money is divided by the number of winners, and the number of times of participations in lottery draws of the winners is divided by the number of times of total lottery draw executions, which are multiplied together to produce the prize money to be paid. The number of times of participations in lottery draws of the winners is determined by searching, extracting, and calculating the number of times of participations in lottery draws from the member information table 41 of the database 2(S702).

In case of only one lottery winner, the prize money of a corresponding grade is multiplied by the number of times of participations in lottery draws of the winner, and an amount of money produced by dividing a value resulting from the above multiplication by the number of times of the entire lottery draw executions is paid to the winner(S703).

Payments of prize money to winners may be realized by using a method such as electronic signatures and the like capable of authenticating the identity of a lottery winner through encryption upon initially inputting a winning lottery number, the winner is authenticated from winners input information encrypted and received, and official institutions such as financial institutions having a certain contract with a web site of the present invention and managing lottery proceeds deposit prize money into an account of a financial institution with which the winner deals(S704).

In paying prize money as stated above, a certain upper limit amount of money is established as to payments in a lump sum for prize money. If prize money over the above upper limit amount occurs due to accumulation of prize money, only the predetermined upper limit amount is paid in a lump sum, and the remaining prize money is partially paid based on a certain standard.

A step next to the above returns to the step S514 of FIG. 5 to put an end to the draw process.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A lottery service system based on the internet, comprising:
at least one user computer having a communication means and for connecting to an internet communication network and participating in a lottery service; and
a web server for storing users information, assigning as users' lottery numbers letters and numbers of predetermined digits inputted from the users, and carrying out an online lottery service by extracting for winning lottery numbers letters or numbers in the highest or lowest incidence from letters or numbers corresponding to respective places of the inputted lottery numbers.

2. The lottery service system as claimed in claim 1, wherein the web server includes:
a database for storing the users information and the lottery numbers inputted from the users;
a database engine for controlling the database;
a web page storage unit for storing web pages as interfaces via which the users input numbers of predetermined digits through the users computer;
a lottery ticket drawing unit for drawing winning numbers based on the lottery numbers inputted from the users;
an electronic payment unit for processing lottery service fees from the users and paying prize money to winners online;
a communication unit for carrying out communications with external; and
a control unit for controlling the system.

3. The lottery service system as claimed in claim 2, wherein the database stores a users table, a lottery ticket number table, and a reservation table.

4. The lottery service system as claimed in claim 3, wherein the users table stores information on user names, IDs, passwords, addresses, telephone numbers, residential registration numbers, account numbers of financial institutions with which the users deal, electronic mail addresses, and the number of times of participations in lottery draws.

5. The lottery service system as claimed in claim 2, wherein the lottery numbers consist of a letter or number of one digit indicating a group and numbers of predetermined digits indicating a lottery number.

6. The lottery service system as claimed in claim 3, wherein the lottery ticket number table stores users IDs, lottery ticket groups, and numbers by predetermined place in lottery numbers.

7. The lottery service system as claimed in claim 3, wherein the reservation table stores the users IDs, lottery numbers, and draw dates through classification based on a predetermined standard.

8. The lottery service system as claimed in claim 2, wherein the lottery draw unit extracts a letter or number indicating a group of a winning lottery number from either of the letters or numbers of groups inputted most, and extracts numbers inputted most by predetermined place as winning numbers from the lottery ticket number table.

9. The lottery service system as claimed in claim 8, wherein the lottery draw unit extracts winning lottery numbers having a group different from the winning lottery number, and winning lottery numbers to winning numbers having the same numbers up to predetermined places including higher and lower places in order from winning numbers having the same last number as that of the winning lottery number to assign grades.

10. A lottery service method based on the internet, comprising steps of:
(1) inputting prospective lottery numbers online from external users;
(2) storing the lottery numbers inputted from the users in a classification database based on a predetermined standard, and drawing a lottery winner by selecting numbers having the largest incidence by place from the stored lottery numbers of plural users as winning numbers at corresponding places and determining a winning lottery number; and
(3) transferring corresponding prize money to accounts of financial institutions of the drawn lottery winners.

11. The lottery service method as claimed in claim 10, wherein the step(1) further includes steps of:
(4) inputting members information in order for internet users to connect to a web server of an internet lottery service site for registrations as members;
(5) storing the members information of the internet users in a database;
(6) performing logins to the web site, and registering prospective lottery numbers and paying lottery draw participation costs;
(7) judging whether to carrying out reservations of the lottery numbers, and, in case that the reservations are desired, inputting corresponding draw dates and lottery numbers and storing them in the database; and
(8) inputting lottery numbers randomly selected through input units of the internet users in case that participating in a lottery draw of the day.

12. The lottery service method as claimed in claim 10, wherein the step(2) further includes steps of:
(9) receiving signals containing lottery numbers of the internet users by a web server of a lottery service site;
(10) extracting the winning lottery number from registered lottery numbers;
(11) drawing a winning lottery number based on the winning numbers;
(12) judging if there is a lottery winner based on the winning numbers;
(13) paying prize money in case there is the lottery winner in the step(12);
(14) transferring and adding, in case there is a remaining amount of money after the payment of the prize money, the remaining amount to a lottery draw of the next day; and
(15) transferring, in case there is not a lottery winner in the step(11), prize money adding the prize money to the prize money of the next day.

13. The lottery service method as claimed in claim 12, wherein the step(11) for drawing a inning lottery number further includes steps of:
(11-1) extracting lottery numbers stored in a lottery ticket number table for storing the lottery numbers and lottery numbers inputted to be preferably drawn on a corresponding date from a reservation table, assigning as a group of the winning lottery number either of a letter or number of the group inputted most for the place of the group from the lottery numbers, and assigning, in case there is duplicated letters of the group inputted most, the group by selecting a letter for the group based on either the descending order or the ascending order; and
(11-2) assigning numbers inputted most by place from the lottery numbers as winning numbers of corresponding places, and assigning, in case that numbers inputted most are duplicated, the winning numbers for corresponding places with any one of the maximum value, minimum value, and intermediate value based on any one way of the descending order and the ascending order.

14. The lottery service method as claimed in claim 13, wherein the step(11-2) for assigning the winning lottery ticket assigns a winning number by applying one random number or letter notarized by a notarial institution to one place of the winning numbers.

15. The lottery service method as claimed in claim 13, wherein the step(11-2) for assigning the winning lottery number assigns a winning number by applying any one of a composite stock exchange index, a change from previous close in the composite stock exchange index, and a Kosdaq index to a specific place of the lottery number.

16. The lottery service method as claimed in claim 12, wherein the prize money payment in the step(13) further comprises steps of:
(13-1) judging whether the lottery winner is plural;
(13-2) dividing, if there is only one lottery winner, the number of times of participations of the lottery winner in lottery draws by the number of times of total lottery draw executions, and paying an amount of money obtained by multiplying the prize money by a division result; and
(13-3) dividing, if there are plural lottery winners, the prize money by the number of lottery winners, dividing the number of times of participations of the lottery winners in lottery draws winner by winner by the number of times of lottery draw executions, and paying prize money by multiplying the two division results.

17. The lottery service method as claimed in any one of claims 10, 12, 13, and 16, wherein the lottery draws are conducted at a predetermined time every day.

18. The lottery service method as claimed in claim 11, wherein the payment of the lottery draw participation costs is carried out by at least one of payments with cards on web browsers, electronic cash of a certain amount of money accumulated, GIRO payments, account transfers, and bills on communication costs added by the participation costs through predetermined contracts with telecommunication companies.
